(19) United States
(12) Patent Application Publication
(10) Pub. No.: US 2022/0114478 A1
(43) Pub. Date: Apr. 14, 2022

(54) SYSTEM AND METHOD FOR ENHANCING INFERENCE MODELS BASED ON PREDICTION DATA

(71) Applicant: SAMSUNG SDS CO., LTD., Seoul (KR)

(72) Inventors: Byung Yong SUNG, Seoul (KR); Chang Ju LEE, Seoul (KR); Jun Cheol LEE, Seoul (KR); Jong Sung KIM, Seoul (KR)

(21) Appl. No.: 17/081,750

(22) Filed: Oct. 27, 2020

(30) Foreign Application Priority Data
Oct. 14, 2020 (KR) 10-2020-0132435

(51) Int. Cl. G06N 20/00; G06N 5/04

(52) U.S. Cl. CPC G06N 20/00; G06N 5/04

(57) ABSTRACT

A system for enhancing a prediction model according to an embodiment includes a storage module configured to receive and store inference data for input data from a prediction model, a retraining module configured to train a retraining model using retraining data including the inference data, and a determination module configured to compare performances of the prediction model and the retraining model and replace the prediction model with the retraining model according to the comparison result.

### TECHNICAL FIELD

The disclosed embodiments relate to a technique for enhancing the accuracy of a prediction model for generating an inference value for a given input using machine learning.

### BACKGROUND ART

A prediction system using machine learning is a system that is trained on existing data using a dataset and performs prediction or inference for the future using the trained data. Such a prediction system constructs a prediction model using past data and performs prediction using the inference model. However, when characteristics of the input data have changed due to a change in an environment (such as location, time, or the like), the accuracy of the prediction system based on the past data may be degraded.

To compensate for such degradation, conventionally, the prediction system is configured to update the existing prediction model through periodic retraining. However, a considerable amount of time is required to accumulate the latest data that can be retrained with and to construct a new model that reflects the latest data, and during this period of time, the existing model with poor accuracy has to be used.

### SUMMARY

The disclosed embodiments are intended to provide a technical means for minimizing performance degradation of a prediction model in a machine learning-based prediction system.

According to an exemplary embodiment, there is provided a system for enhancing a prediction model including a storage module configured to receive and store inference data for input data from a prediction model; a retraining module configured to train a retraining model using retraining data including the inference data; and a determination module configured to compare performances of the prediction model and the retraining model and replace the prediction model with the retraining model according to the comparison result.

The system may further include an abnormality detection module configured to detect an abnormality in the inference data, wherein the retraining module trains the retraining model when the abnormality is detected by the abnormality detection module.

The storage module may create groups of the inference data according to a preset unit time period and store the groups of the inference data.

The retraining module may generate the retraining data by replacing at least part of training data of the prediction model with the inference data.

The capacity of the training data and the capacity of the retraining data may be set to be the same.

The system may further include a distribution module configured to distribute the input data to the prediction model and the retraining model.

The determination module may compare prediction accuracy of first inference data output from the prediction model and prediction accuracy of second inference data output from the retraining model with respect to the distributed input data, and determine whether to replace the prediction model with the retraining model.

According to another exemplary embodiment, there is provided a method for enhancing a prediction model, which is performed in a computing device including one or more processors and a memory in which one or more programs to be executed by the one or more processors are stored, the method including: a storing operation of receiving and storing inference data for input data from a prediction model; a retraining operation of training a retraining model using retraining data including the inference data; and a determining operation of comparing performances of the prediction model and the retraining model and replacing the prediction model with the retraining model according to the comparison result.

The method further includes an operation of detecting an abnormality in the inference data, wherein the retraining operation includes training the retraining model when the abnormality is detected in the operation of detecting an abnormality.

The storing operation may include creating groups of the inference data according to a preset unit time period and storing the groups of the inference data.

The retraining operation may include generating the retraining data by replacing at least part of training data of the prediction model with the inference data.

The capacity of the training data and the capacity of the retraining data may be set to be the same.

The method may further include an operation of distributing the input data to the prediction model and the retraining model.

The determining operation may include comparing prediction accuracy of first inference data output from the prediction model and prediction accuracy of second inference data output from the retraining model with respect to the distributed input data, and determining whether to replace the prediction model with the retraining model.

According to still another exemplary embodiment, there is provided a computer program stored in a non-transitory computer-readable storage medium, the computer including one or more instructions that, when executed by a computing device including one or more processors, cause the computing device to perform operations of: receiving and storing inference data for input data from a prediction model; training a retraining model using retraining data including the inference data; and comparing performances of the prediction model and the retraining model and replacing the prediction model with the retraining model according to the comparison result.

According to the disclosed embodiments, a prediction model is retrained using inference data before the model replacement period of the prediction model arrives, and the performances of the retraining model and the existing prediction model are compared to utilize the model with a higher performance, thereby minimizing the performance degradation of the prediction model.

### BRIEF DESCRIPTION OF THE DRAWINGS

FIG. 1 is an exemplary diagram for explaining an operation process of a prediction system through machine learning;

FIG. 2 is a block diagram illustrating a system 200 for enhancing a prediction model according to an embodiment;

FIGS. 3 to 5 are exemplary diagrams for explaining an inference data collection process and a retraining process using the inference data according to an embodiment;

FIG. 6 is a flowchart illustrating a method 600 of enhancing a prediction model according to an embodiment; and

FIG. 7 is a block diagram illustrating an example of a computing environment 10 including a computing device suitable for use in example embodiments.

### DETAILED DESCRIPTION

Hereinafter, specific exemplary embodiments of the present disclosure will be described with reference to the drawings. The following detailed description is provided to assist in comprehensive understanding of methods, apparatuses, and/or systems described herein. However, this is merely an example, and the present disclosure is not limited thereto.

When detailed description of known art related to the present disclosure is determined to unnecessarily obscure the subject matter of the present disclosure in describing exemplary embodiments of the present disclosure, the detailed description will be omitted. The terms to be described below are terms defined in consideration of functions in the present disclosure and may be changed according to an intention of a user or an operator or practice. Therefore, definitions thereof will be determined based on content of the entire specification. The terms used in the detailed description are merely intended to describe the exemplary embodiments of the present disclosure and should not be limited in any way. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, operations, operations, elements, and/or components, but do not preclude the presence or addition of one or more other features, integers, operations, operations, elements, components, and/or groups thereof

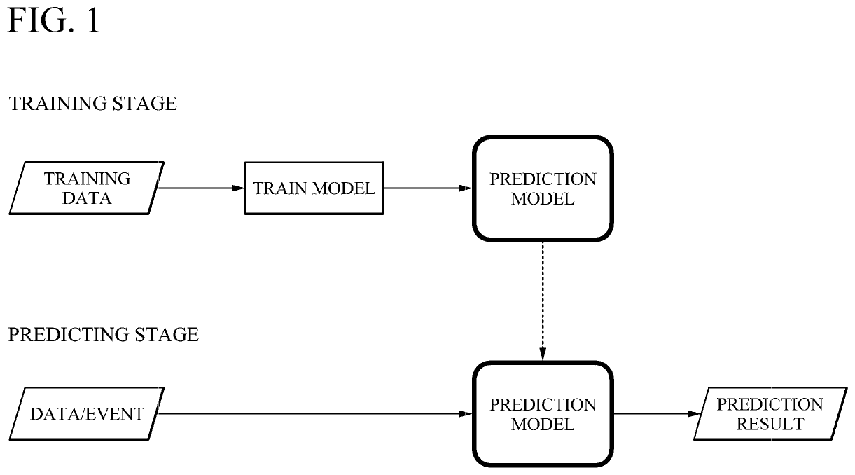

FIG. 1 is an exemplary diagram for explaining an operation process of a prediction system through machine learning. Machine learning largely consists of two stages. The first stage is a training stage in which a prediction model is repeatedly trained using large datasets. The second stage is a predicting stage in which prediction result or inference result is derived by performing prediction from input data or event using the trained prediction model. As such, the prediction system aims to provide an inference value for a given input using a model developed in the training stage.

The prediction system requires low latency and high throughput for high-speed, mass data processing, and requires maintaining the accuracy of a prediction model used for prediction. Performance degradation of most prediction models appears in the form of skewness, outliers, and concept drift. In general, the accuracy of a prediction model tends to deteriorate over time. Therefore, there is a need for a method for effectively maintaining the accuracy of the prediction model.

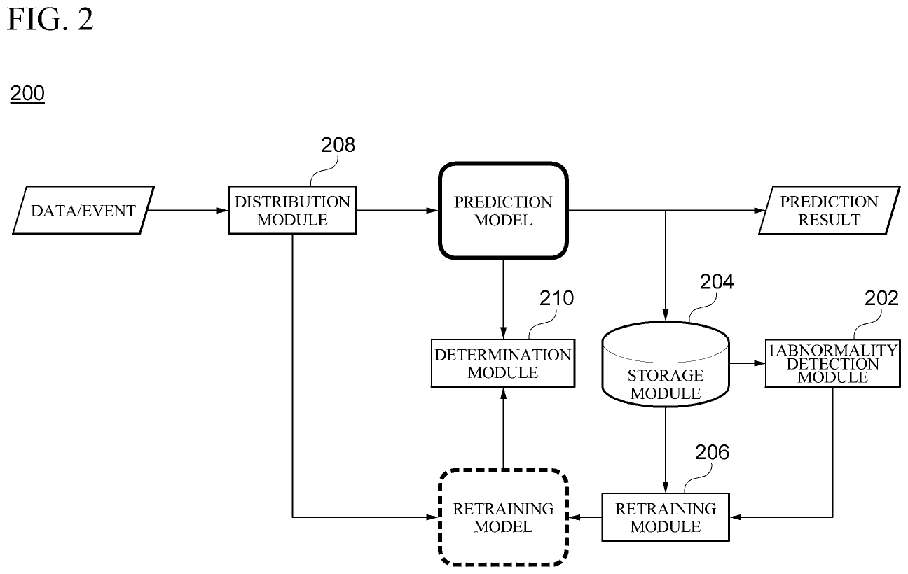

FIG. 2 is a block diagram illustrating a system 200 for enhancing a prediction model according to an embodiment. The system 200 for enhancing a prediction model according to an embodiment is a system for preventing model performance degradation of the prediction model used in the above-described prediction system. In this case, the prediction model is a system for deriving inference data (prediction result) through inference on given data or event. As illustrated, the system 200 for enhancing a prediction model according to an embodiment includes an abnormality detection module 202, a storage module 204, a retraining module 206, a distribution model 208, and a determination module 210.

The abnormality detection module 202 detects an abnormality in inference data derived from the prediction model. When an abnormality is detected from the inference data, it means that the prediction accuracy of the prediction model is deteriorated. In one embodiment, when a skewness, outlier, or concept drift of a certain level or higher is detected from the inference data, the abnormality detection module 202 may determine that an abnormality in the inference data has occurred.

The storage module 204 receives and stores the inference data derived from the prediction model. In one embodiment, the storage module 204 may store the inference data in the same data format as training data used for training of the prediction model. That is, the inference data stored in the storage module 204 may include an input value input to the prediction model. The inference data stored in this way may be used for the abnormality detection by the abnormality detection module and the training of a retrained model by the retraining module 206.

In one embodiment, the storage module 204 may create groups of the inference data according to a preset unit period and store the groups of the inference data. In other words, the storage module 204 may store the inference data in a mini-batch form for each preset unit period, and the retraining module 206, which will be described below, may utilize the inference data stored as groups may be utilized for retraining a retraining model.

The retraining module 206 trains the retraining model using retraining data including the inference data. Here, the retraining model may be a machine learning model having the same structure as the above-described prediction model. In one embodiment, the retraining module 206 may train the retraining model when an abnormality in the inference data is detected by the abnormality detection module 202. When an abnormality occurs in the inference data, it means that the past data used for training the prediction model has no longer explanatory power to predict the future. The simplest way to address this issue is to reconstruct the prediction model by updating the latest data when an abnormality occurs. However, this method has problems in that it takes time to obtain the latest data and update the prediction model using the obtained latest data and the existing model whose performance has already deteriorated has to be used during this period of time. To address these problems, in the disclosed embodiments, the inference data derived from the prediction model is utilized as modeling data until the latest data is secured, thereby preventing the performance degradation of the prediction model.

In one embodiment, the retraining module 206 may generate the retraining data by replacing at least part of the training data of the prediction model with the inference data. For example, the retraining module 206 may add one or more batches of the inference data stored in a mini-batch form in the storage module 204 to the training data, and generate the retraining data using a moving window method by which the same number of the oldest training data as the number of newly added inference data is removed. In this case, the capacity of the training data and the capacity of the retraining data are set to be the same. As described above, when the training data and the retraining data are configured to be the same in numbers, it is possible to prevent model performance improvement bias due to an increase in the number of data in the future performance evaluation of the prediction model and the retraining model.

Then, the distribution module 208 distributes the input data to the prediction model and the retraining model. According to an embodiment, the distribution module may distribute the input data to the prediction model and the retraining model according to a preset distribution ratio, or transmit the same input data to both the prediction model and the retraining model.

In one embodiment, the distribution module 208 may distribute the input data using a pub/sub structure. In the pub/sub structure, input data is stored in the form of a topic, which is registered in a topic of a service module connected to the prediction model and the retraining model to each generate an inference result.

Then, the determination module 210 compares the performances of the prediction model and the retraining model, and replaces the prediction model with the retraining model according to the comparison result. The determination module 210 may compare prediction accuracy between first inference data output from the prediction model and second inference data output from the retraining model with respect to the distributed input data and determine whether to replace the prediction model with the retraining model.

In one embodiment, the determination module 210 may compare the performances of the prediction model and the retraining model using an AB testing method. Specifically, the distribution module 208 may distribute the same input data to the prediction model and the retraining model, and the determination module 210 may compare the inference data of the prediction model and the inference data of the relearning model with respect to the same input data and determine that the model with fewer abnormalities has a higher performance. If it is determined that the performance of the retraining model is lower than that of the prediction model, the determination module 210 may maintain the existing prediction model. However, on the contrary, when the performance of the retraining model is determined to be higher than that of the prediction model, the determination module 210 may replace the prediction model with the retraining model.

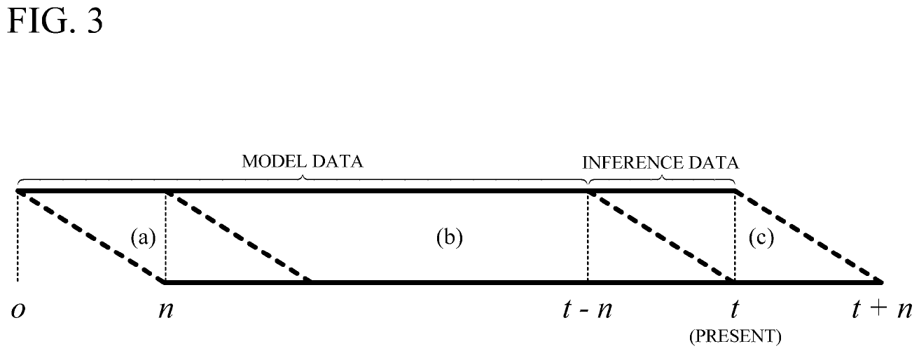

FIGS. 3 to 5 are exemplary diagrams for explaining an inference data collection process and a retraining process using the inference data according to an embodiment. In FIGS. 3 to 5, the upper line of two parallel horizontal lines indicates input data, the lower line indicates result data for the input data, and a horizontal axis indicates the passage of time. It is assumed that there is a time difference of n between the input data and the result data.

As shown in FIG. 3, it is assumed that time t+n is predicted at time t by using a prediction model. In this case, data that can be used to create the prediction model is data up to time t−n (indicated as “model data” in FIG. 3). If n is assumed to be the optimal period for model update, the same model may be used during a period from time t to time t+1. However, as described above, since the performance of the model generally decreases as time elapses, there is a need for a method to compensate for the performance degradation of the prediction model between t to t+n, that is, even before the model update.

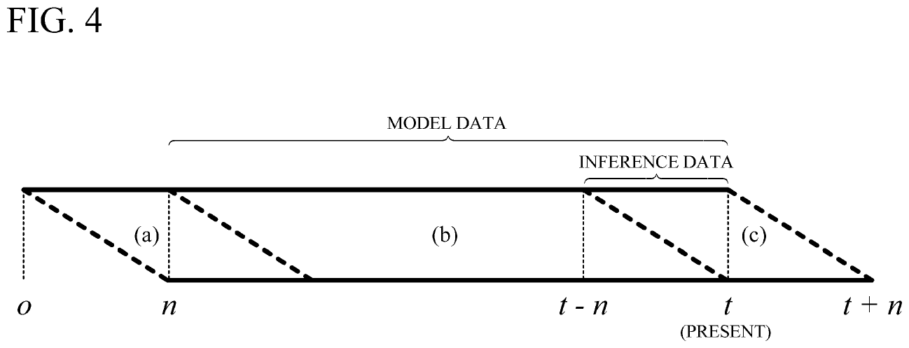

To this end, in the disclosed embodiment, as shown in FIG. 4, retraining data is generated using a moving window method by which inference data from time t−n to time t are added to the model data of FIG. 3 and old data is removed instead of the new inference data, and the retraining model is configured to be generated using the retraining data. In this case, it should be noted that the inference data is not actual data, but data predicted by the prediction model. This is because there is a time difference of n until an actual result value of the input data is obtained, so an actual result value after time t−n cannot be known at time t. If the performance of the retraining model generated in this way is superior to that of the existing prediction model, the prediction model is replaced with the retraining model.

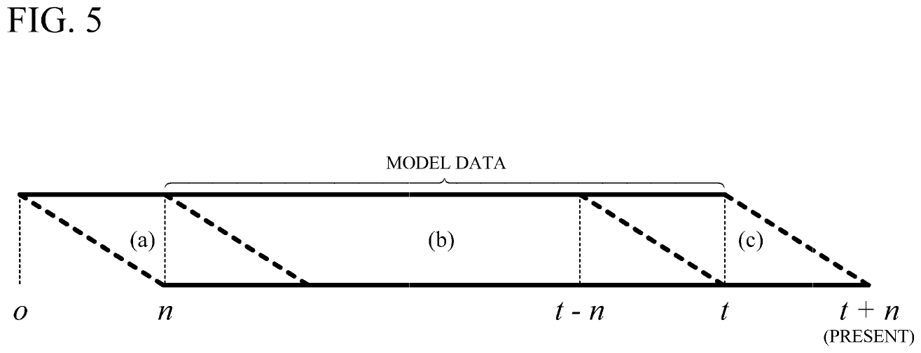

Thereafter, at time t+n that is a model update time, a new prediction model is constructed using data up to time tt, as shown in FIG. 5.

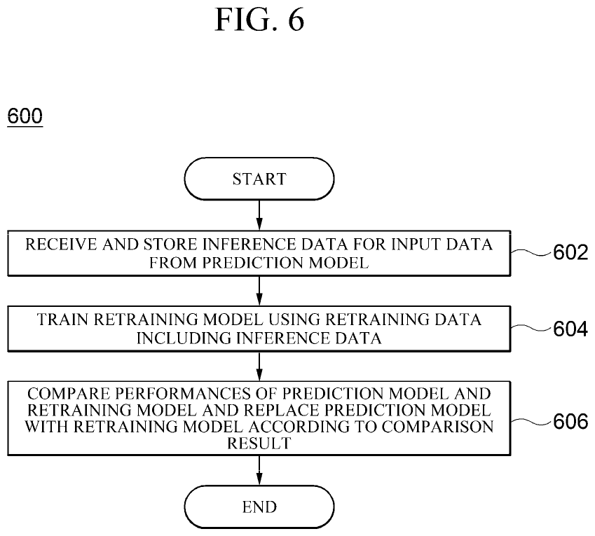

FIG. 6 is a flowchart illustrating a method 600 of enhancing a prediction model according to an embodiment. The illustrated method may be performed by a computing device including one or more processors and a memory in which one or more programs to be executed by the one or more processors are stored, for example, the above-described system 200 for enhancing a prediction model. In the illustrated flowchart, at least some of the operations may be performed in different order or may be combined into fewer operations or further divided into more operations. In addition, some of the operations may be omitted, or one or more extra operations, which are not illustrated, may be added to the flowchart and be performed.

In operation 602, the storage module 204 of the system 200 for enhancing a prediction model receives and stores inference data for input data from a prediction model.

In operation 604, the retraining module 206 trains a retraining model using retraining data including the inference data.

In operation 606, the determination module 210 compares the performances of the prediction model and the retraining model, and replaces the prediction model with the retraining model according to the comparison result.

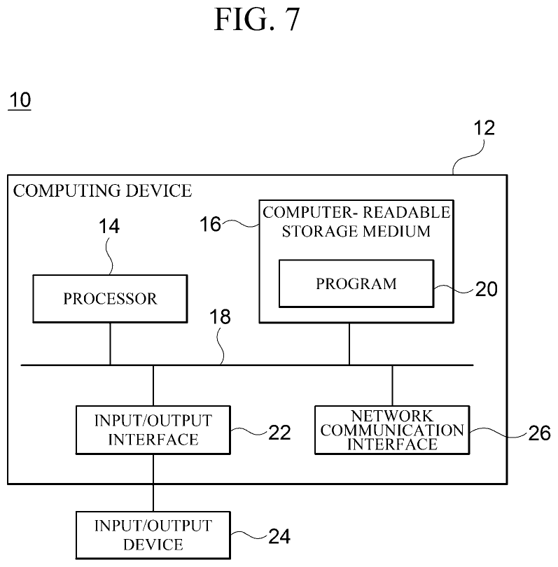

FIG. 7 is a block diagram illustrating an example of a computing environment 10 including a computing device suitable for use in example embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be the system 200 for enhancing a prediction model according to the embodiments of the present disclosure. The computing device 12 includes at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable instructions, and the computer executable instructions may be configured to, when executed by the processor 14, cause the computing device 12 to perform operations according to the exemplary embodiment.

The computer-readable storage medium 16 is configured to store computer executable instructions and program codes, program data and/or information in other suitable forms. The programs stored in the computer-readable storage medium 16 may include a set of instructions executable by the processor 14. In one embodiment, the computer-readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 interconnects the various other components of the computing device 12, including the processor 14 and computer readable storage medium 16.

The communication bus 18 connects various other components of the computing device 12 including the processor 14 and the computer readable storage medium 16. The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

Meanwhile, the embodiments of the present disclosure may include a computer readable recording medium including a program for executing methods described in this specification on a computer. The computer readable recording medium may include a program instruction, a local data file, a local data structure, and/or combinations and sub-combinations thereof. The medium may be specially designed and constructed for the purpose of the present disclosure, or may be well-known and available to those having skill in the computer software arts. Examples of the computer readable recording medium include magnetic media such as a hard disk, a floppy disk, and a magnetic tape, optical media such as a compact disc read-only memory (CD-ROM) and a digital versatile disc (DVD)-ROM, and a hardware device such as a read only memory (ROM), random-access memory (RAM), and a flash memory, which is specially designed to store and execute program commands. Examples of the program commands include an advanced language code which the computer can execute using an interpreter as well as a machine language code made by compilers.

While the present disclosure has been described in detail above with reference to representative exemplary embodiments, it should be understood by those skilled in the art that the exemplary embodiments may be variously modified without departing from the scope of the present disclosure. Therefore, the scope of the present disclosure is defined not by the described exemplary embodiments but by the appended claims and encompasses equivalents that fall within the scope of the appended claims.

1. A system for enhancing a prediction model, comprising:
a storage module configured to receive and store inference data for input data from a prediction model;
a retraining module configured to train a retraining model using retraining data including the inference data; and
a determination module configured to compare performances of the prediction model and the retraining model and replace the prediction model with the retraining model according to the comparison result.

2. The system of claim 1, further comprising an abnormality detection module configured to detect an abnormality in the inference data,
wherein the retraining module is configured to train the retraining model when the abnormality is detected by the abnormality detection module.

3. The system of claim 1, wherein the storage module is configured to create groups of the inference data according to a preset unit time period and store the groups of the inference data.

4. The system of claim 3, wherein the retraining module is configured to generate the retraining data by replacing at least part of training data of the prediction model with the inference data.

5. The system of claim 3, wherein a capacity of the training data and a capacity of the retraining data are set to be the same.

6. The system of claim 1, further comprising a distribution module configured to distribute the input data to the prediction model and the retraining model.

7. The system of claim 6, wherein the determination module is configured to compare prediction accuracy of first inference data output from the prediction model and prediction accuracy of second inference data output from the retraining model with respect to the distributed input data, and determine whether to replace the prediction model with the retraining model.

8. A method of enhancing a prediction model, which is performed in a computing device including one or more processors and a memory in which one or more programs to be executed by the one or more processors are stored, the method comprising:
a storing operation of receiving and storing inference data for input data from a prediction model;
a retraining operation of training a retraining model using retraining data including the inference data; and
a determining operation of comparing performances of the prediction model and the retraining model and replacing the prediction model with the retraining model according to the comparison result.

9. The method of claim 8, further comprising an operation of detecting an abnormality in the inference data,
wherein the retraining operation comprises training the retraining model when the abnormality is detected in the operation of detecting an abnormality.

10. The method of claim 8, wherein the storing operation comprises creating groups of the inference data according to a preset unit time period and storing the groups of the inference data.

11. The method of claim 10, wherein the retraining operation comprises generating the retraining data by replacing at least part of training data of the prediction model with the inference data.

12. The method of claim 10, wherein a capacity of the training data and a capacity of the retraining data are set to be the same.

13. The method of claim 8, further comprising an operation of distributing the input data to the prediction model and the retraining model.

14. The method of claim 13, wherein the determining operation comprises comparing prediction accuracy of first inference data output from the prediction model and prediction accuracy of second inference data output from the retraining model with respect to the distributed input data, and determining whether to replace the prediction model with the retraining model.

15. A computer program stored in a non-transitory computer-readable storage medium, the computer program comprising one or more instructions that, when executed by a computing device including one or more processors, cause the computing device to perform:
a storing operation of receiving and storing inference data for input data from a prediction model;
a retraining operation of training a retraining model using retraining data including the inference data; and
a determining operation of comparing performances of the prediction model and the retraining model and replacing the prediction model with the retraining model according to the comparison result.
